(19) United States
(12) Patent Application Publication
(10) Pub. No.: US 2020/0265506 A1
(43) Pub. Date: Aug. 20, 2020

(54) Systems and Methods for Managing a Marketplace of Homemade Foods

(71) Applicant: Mukaddes Sablak, East Stroudsburg, PA (US)

(72) Inventor: Mukaddes Sablak, East Stroudsburg, PA (US)

(21) Appl. No.: 16/796,938

(22) Filed: Feb. 20, 2020

Related U.S. Application Data
(60) Provisional application No. 62/808,190, filed on Feb. 20, 2019.

(51) Int. Cl. G06Q 30/06; G06Q 10/08; G06Q 50/12

(52) U.S. Cl. CPC G06Q 30/0641; G06Q 30/0625; G06Q 50/12; G06Q 10/0832

(57) ABSTRACT

A method for managing a marketplace of homemade foods provides a system for connecting consumers with local chefs. The system enables home chefs to obtain necessary certifications and licensing to sell their culinary creations and provides a platform to facilitate such interactions. The system includes at least one consumer account and a plurality of chef accounts managed by at least one remote server. Thus, the system enables consumer accounts to engage with the plurality of chef accounts and allows the plurality of chef accounts to engage with the consumer accounts and helpful resources through the remote server. Standardized containers and supplies ensure that consumer meals are of sufficient quantity to satisfy hunger. The remote server may apply artificial intelligence (AI) or machine learning (ML) methodologies, including, but not limited to, clustering, random forest, regression, prediction, or other statistical modeling, to analyze data and provide recommendations to chefs and consumers.

The current application claims a priority to the U.S. Provisional Patent application Ser. No. 62/808,190 filed on Feb. 20, 2019.

### FIELD OF THE INVENTION

The present invention generally relates to the food industry and e-commerce businesses. More specifically, the present invention relates to systems and methods for managing a marketplace of homemade foods which facilitate online homemade food sales powered by artificial intelligence (AI), machine learning (ML), and various standardization methods.

### BACKGROUND OF THE INVENTION

Historically, meal preparation and enjoyment has been a family activity. Children and parents would gather around a pot of stew or a roast and salivate before diving in with fork in hand. Today, however, meals and eating have become a matter of convenience. All too often, meals are eaten quickly in cafes, on the road, or skipped altogether. It seems that the days of gathering around a table for a homecooked meal are a thing of the past. However, with the increasing availability of ingredient delivery services and recipe suggestions, such meals are regaining popularity. Many such services offer ingredients that are safely packaged for delivery, with instructions and labels that assist the user in learning how to cook. Unfortunately, such services still fail to capture the essence of home cooking that is sorely missing from the lives of so many. What is needed is a system that can enable users to obtain homecooked food. Further desirable is a system that allows a user to have such food cooked fresh and delivered with all dietary restrictions and meal preferences accounted for.

The present invention addresses these issues. An objective of the present invention is to provide systems and methods for online homemade food sales powered by artificial intelligence (AI) or machine learning (ML), standardization, and other plurality of methodologies. The present invention provides a platform comprising a software application, preferably referred to as Foodways App. The software application of the present invention provides a unique opportunity for users to explore the aspects of food people have forgotten such as indulgence and wellness which can be provided in an affordable and sustainable way. The platform of the present invention allows home chefs to share their cooking with health and community conscious consumers. Furthermore, the platform provided by the present invention expands the role of sharing economy in our society through the food industry. The present invention offers a platform for fun, empowerment, and freedom for those who love to cook and enjoy homecooked meals. To contribute to the community's cohesion and strength and to create incredible stories to overcome the challenges of life, the platform of the present invention invites anyone who loves to cook to join the platform of the present invention to cook from home utilizing the software application of the present invention and a plurality of tools provided by the system of the present invention. The platform of the present invention enables users to work independently, work at their own time with their own recipes, and enables consumers to have unique culinary experiences with a plurality of chefs available in multiple locations which can be easily found through the software application of the present invention. Standardized containers and supplies ensure that consumer meals are of sufficient quantity to satisfy hunger.

### BRIEF DESCRIPTION OF THE DRAWINGS

FIG. 1 is a block diagram illustrating the system of the present invention.

FIG. 2 is a flowchart illustrating the overall process for the method of the present invention.

FIG. 3 is a flowchart illustrating the subprocess of searching for a chef.

FIG. 4 is a flowchart illustrating the subprocess of searching for a favorite recipe.

FIG. 5 is a flowchart illustrating the subprocess of providing a new recipe challenge or request.

FIG. 6 is a flowchart illustrating the subprocess of providing delivery by the chef.

FIG. 7 is a flowchart illustrating the subprocess of providing delivery by an alternative delivery option instead of delivery by the chef.

FIG. 8 is a flowchart illustrating the subprocess of providing delivery by consumer pickup.

FIG. 9 is a flowchart illustrating the subprocess of providing delivery by internal pickup.

FIG. 10 is a flowchart illustrating the subprocess of providing delivery by external pickup.

FIG. 11 is a flowchart illustrating the subprocess of providing chefs with educational resources.

FIG. 12 is a flowchart illustrating the subprocess of connecting chefs to suppliers.

FIG. 13 is a continuation of FIG. 12.

FIG. 14 is a flowchart illustrating the subprocess of generating food labels.

FIG. 15 is a flowchart illustrating the subprocess of providing the consumer with updates from the chef.

FIG. 16 is a flowchart illustrating the subprocess of enabling feedback reviews.

FIG. 17 is a flowchart illustrating the subprocess of generating artificial intelligence (AI) suggestions for the chef.

FIG. 18 is a flowchart illustrating the subprocess of providing specified portions in standardized food containers.

FIG. 19 is a diagram of the present invention illustrating the business system of the platform of the present invention.

FIG. 20 is a diagram of the present invention illustrating the plurality of tools provided to the plurality of cooks of the present invention.

FIG. 21 is a diagram of the present invention illustrating the plurality of variables in the user profile of the plurality of cooks of the present invention.

FIG. 22 is a diagram of the present invention illustrating the groceries services provided by the present invention to the plurality of cooks.

FIG. 23 is a diagram of the present invention illustrating the plurality of supply features provided by the present invention to the plurality of cooks.

FIG. 24 is a diagram of the present invention illustrating the plurality of legal services provided by the present invention to the plurality of cooks.

FIG. 25 is a diagram of the present invention illustrating the plurality of educational services provided by the present invention.

FIG. 26 is a diagram of the present invention illustrating the plurality of labeling services provided by the present invention.

FIG. 27 is a diagram of the present invention illustrating the plurality of delivery services provided by the present invention.

FIG. 28 is a diagram of the present invention illustrating the user registration process of the present invention.

FIG. 29 is a diagram of the present invention illustrating the plurality of variables in the user profile of the plurality of consumers of the present invention.

FIG. 30 is a diagram of the present invention illustrating the plurality of payment services provided by the present invention.

FIG. 31 is a diagram of the present invention illustrating the supply system of the present invention.

FIG. 32 is a diagram of the present invention illustrating the delivery system of the present invention.

FIG. 33 is a diagram of the present invention illustrating the delivery operation process of the present invention.

FIG. 34 is a diagram of the present invention illustrating the first-time cook registration process of the present invention.

FIG. 35 is a diagram of the present invention illustrating the first-time consumer registration process of the present invention.

FIG. 36 is a diagram of the present invention illustrating the consumer order submission process of the present invention.

FIG. 37 is a diagram of the present invention illustrating the cook order preparation process of the present invention.

FIG. 38 is a diagram of the present invention illustrating the order notification and delivery processes of the present invention.

### DETAILED DESCRIPTION OF THE INVENTION

All illustrations of the drawings are for the purpose of describing selected versions of the present invention and are not intended to limit the scope of the present invention.

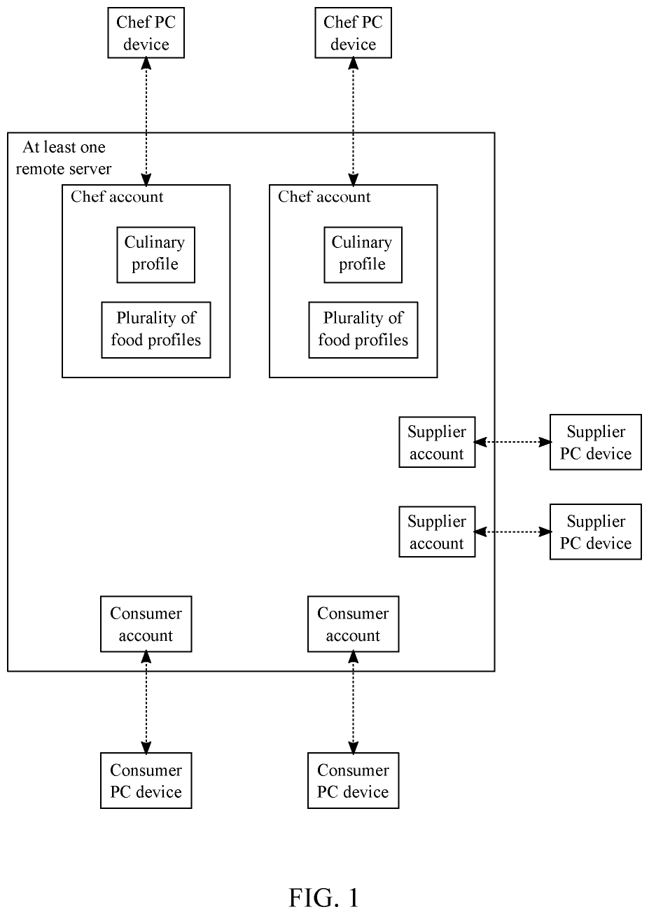

The present invention is a method for managing a marketplace of homemade foods that provides a system for connecting consumers with local chefs. The present invention enables home chefs to obtain necessary certifications and licensing to sell their culinary creations and provides a platform to facilitate such interactions. The system of the present invention includes at least one consumer account managed by at least one remote server, wherein the consumer account is associated with at least one consumer personal computing (PC) device (Step A), which is shown in FIG. 1. The at least one consumer account relates to a user who is interested in obtaining a homecooked meal. The at least one remote server is an electronic unit capable of connecting electronic devices, applying programmatic logic, and storing relevant data. The at least one consumer PC device relates to any of a variety of electronic devices, including smartphones, laptop computers, desktop computers, and more, that are capable of connecting a consumer to the remote server. The present invention further includes a plurality of chef accounts managed by the remote server, wherein each chef account is associated with a corresponding chef PC device (Step B). The plurality of chef accounts relates to a set of users who are interested in preparing and selling or distributing homecooked meals. The corresponding chef PC device relates to any of a variety of electronic devices, including smartphones, laptop computers, desktop computers, and more, that are capable of connecting a chef to the remote server.

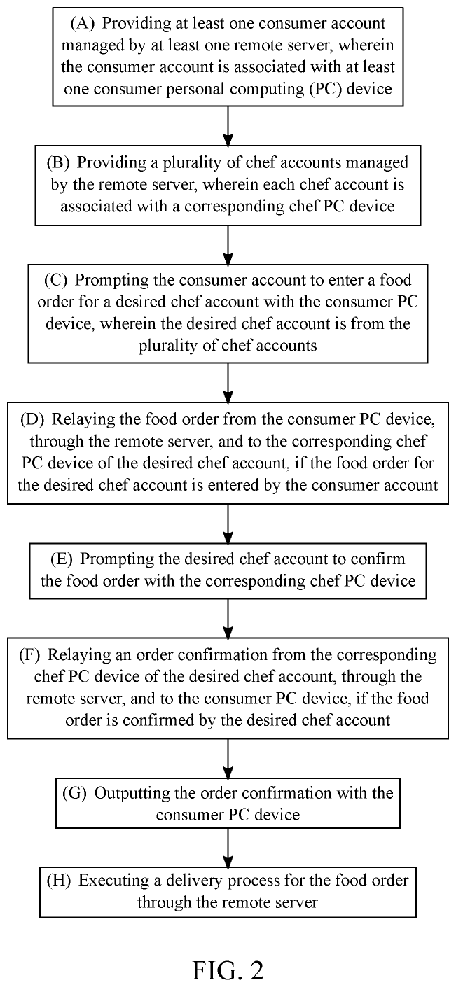

As can be seen in FIG. 2, the present invention enables consumer accounts to engage with the plurality of chef accounts and allows the plurality of chef accounts to engage with the consumer accounts and helpful resources through the remote server. The consumer account is prompted to enter a food order for a desired chef account with the consumer PC device, wherein the desired chef account is from the plurality of chef accounts (Step C). The food order may include a variety of information, including, but not limited to, a desired meal, specified health restrictions, allergies, special instructions, cost, and more. The desired chef account relates to a chef account chosen by the consumer account to prepare and manage food for the consumer account. The food order is relayed from the consumer PC device, through the remote server, and to the corresponding chef PC device of the desired chef account, if the food order for the desired chef account is entered by the consumer account (Step D). Thus, the remote server may interpret the food order and relay the most appropriate display to the desired chef account, including, but not limited to, the food order, recommendations for ingredients, cooking instructions, and a variety of other helpful tips or pointers. The remote server may apply artificial intelligence (AI) or machine learning (ML) methodologies, including, but not limited to, clustering, random forest, regression, prediction, or other statistical modeling, in order to analyze the consumer account and the food order and determine the most appropriate information to display to the desired chef account.

Upon receipt of the food order, the desired chef account is presented with options for interacting with the food order and ultimately making critical decisions about accepting or denying the cooking job. The desired chef account is prompted to confirm the food order with the corresponding chef PC device (Step E). In this way, the desired chef account may accept or decline requests to produce food for a given consumer account. An order confirmation is relayed from the corresponding chef PC device of the desired chef account, through the remote server, and to the consumer PC device, if the food order is confirmed by the desired chef account (Step F). The order confirmation may contain information including, but not limited to, a meal name, preparation time estimate, completion time estimate, cost, ingredient list, delivery information, and more.

The order confirmation is outputted with the consumer PC device (Step G). Thus, the consumer PC device displays relevant information to the consumer account, allowing the consumer account to identify another desired chef account if necessary. Finally, a delivery process is executed for the food order through the remote server (Step H). Therefore, the consumer account may acquire the prepared food through a mutually agreed-upon method when the food preparation has been completed.

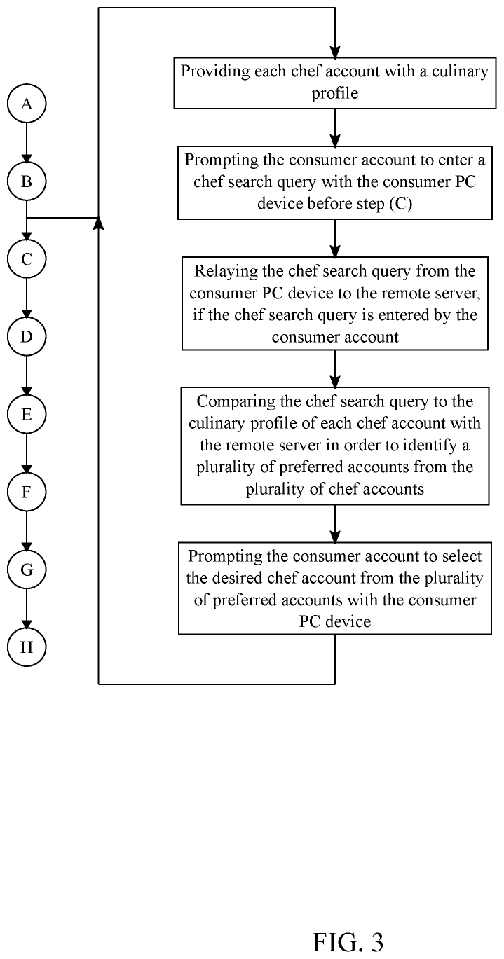

The system of the present invention preferably employs AI or ML practices in programming to enable the remote server to provide suggestions about the plurality of chef accounts to the consumer account based upon a variety of relevant data points, including, but not limited to, previous consumer account food orders, location, time, reviews, and more information. Each chef account is provided with a culinary profile, which is shown in FIG. 3. The culinary profile relates to information about a particular chef account of the plurality of chef accounts, including, but not limited to, service history, location, reviews, and more. The consumer account is prompted to enter a chef search query with the consumer PC device before Step C. The chef search query preferably relates to a text input that enables the consumer account to search for different foods, ingredients, styles, or other preferences that are helpful in refining a list of chef accounts. The chef search query is subsequently relayed from the consumer PC device to the remote server, if the chef search query is entered by the consumer account. In this way, the remote server receives data necessary to process next steps. Such data may be relayed to the remote server either upon submission of the form or asynchronously as the consumer account types or otherwise enters inputs. The chef search query is compared to the culinary profile of each chef account with the remote server in order to identify a plurality of preferred accounts from the plurality of chef accounts. Such a comparison enables determination of best-suited chefs for a particular recipe or cooking style, as determined from the chef search query. This comparison may utilize AI or ML methodologies, including, but not limited to, clustering, random forest, regression, prediction, or other statistical modeling, in order to analyze the culinary profiles of each chef account. The consumer account is then prompted to select the desired chef account from the plurality of preferred accounts with the consumer PC device. Thus, the remote server assists the consumer account in determining a desired chef account by prefiltering through existing chef accounts.

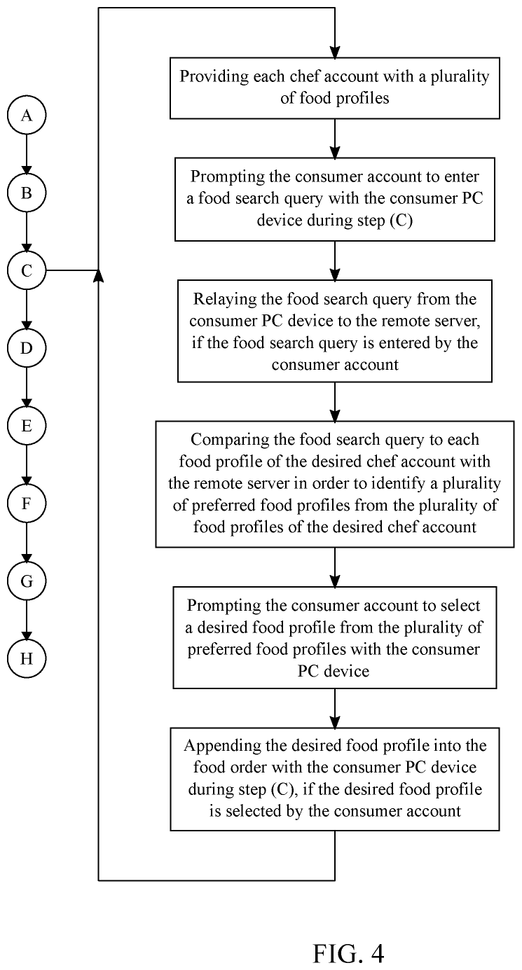

As can be seen in FIG. 4, it is highly advantageous to be aware of the cooking style and preferred dishes for each chef. To enable this, each chef account is provided with a plurality of food profiles. The plurality of food profiles relates to the set of dishes or culinary creations that have been made by a chef. The consumer account is prompted to enter a food search query with the consumer PC device during Step C. The food search query relates to an input that contains information regarding a desired dish. Next, the food search query is relayed from the consumer PC device to the remote server, if the food search query is entered by the consumer account. This allows the remote server to process the received food search query to return different results to the consumer account and to store the food search query for future use. The food search query is compared to each food profile of the desired chef account with the remote server in order to identify a plurality of preferred food profiles from the plurality of food profiles of the desired chef account. Thus, the remote server determines chef appropriateness based upon the history and competence of the desired chef account. The consumer account is prompted to select a desired food profile from the plurality of preferred food profiles with the consumer PC device. This enables the consumer account to identify a specific food or dish that is appetizing to the consumer account after determining the best chefs for the job. Finally, the desired food profile is appended into the food order with the consumer PC device during Step C, if the desired food profile is selected by the consumer account. This arrangement ensures that the desired food profile is received by the desired chef account along with other necessary information regarding the consumer account preferences and other information contained within the food order.

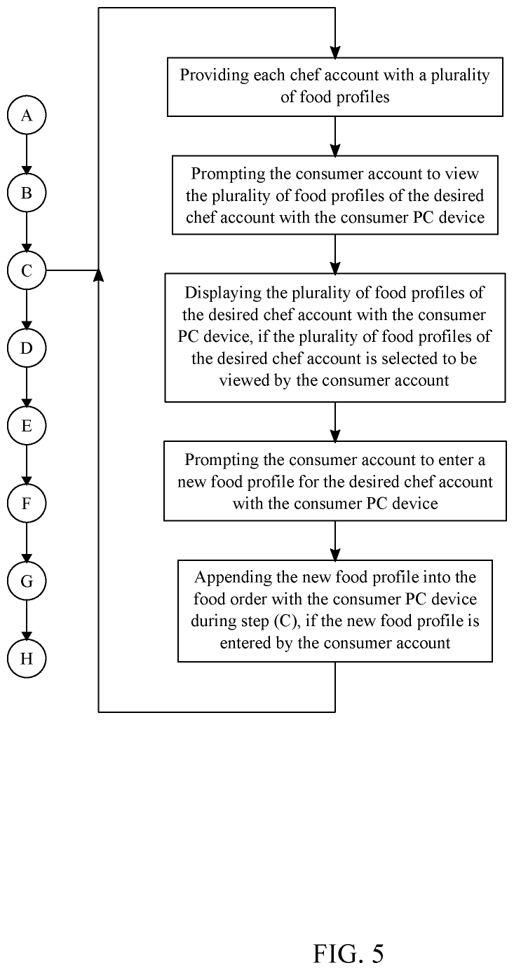

A consumer account observing the various profiles of the plurality of chefs may become inspired to eat a particular dish that is not being served by any of the plurality of chefs. To enable this, each chef account is provided with a plurality of food profiles. The plurality of food profiles relates to the set of dishes or culinary creations that have been made by a chef. The consumer account is prompted to view the plurality of food profiles of the desired chef account with the consumer PC device, which is shown in FIG. 5. In this way, the consumer account is able to access the different chef profiles, preferably sorted by distance, consumer preferences, or a variety of other sorting criteria. The plurality of food profiles of the desired chef account is displayed with the consumer PC device, if the plurality of food profiles of the desired chef account is selected to be viewed by the consumer account. Thus, the consumer account gains knowledge of the cooking history and known dishes of the desired chef account. Once viewing the desired chef account, the consumer account is prompted to enter a new food profile for the desired chef account with the consumer PC device. In this way, the consumer account may enter information, including any or each of a dish name, ingredients, instructions, and more, in order to describe the precise dish or meal desired by the consumer account. Finally, the new food profile is appended into the food order with the consumer PC device during Step C, if the new food profile is entered by the consumer account. This arrangement ultimately provides the desired chef account with new dishes, thus enhancing the offerings of the desired chef account and simultaneously providing the consumer account with a novel dish.

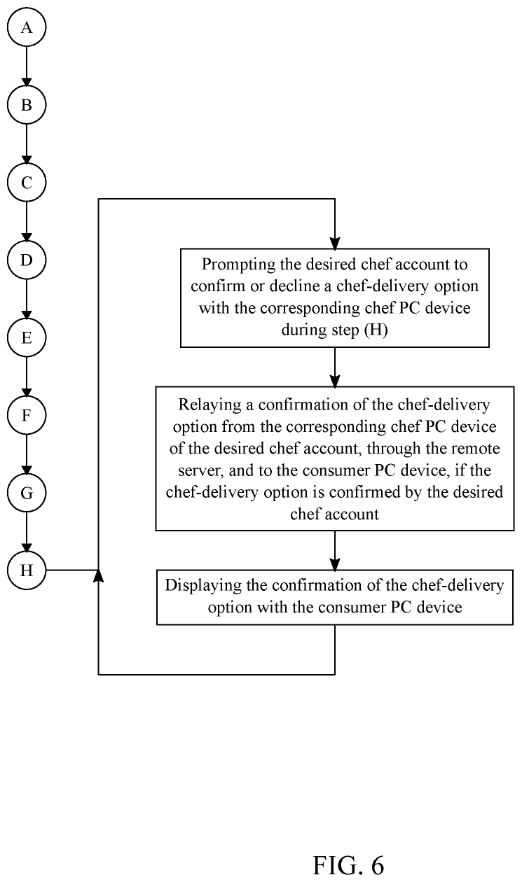

As can be seen in FIG. 6, the present invention requires a system by which the consumer may acquire created foods. To this end, the desired chef account is prompted to confirm or decline a chef-delivery option with the corresponding chef PC device during Step H. The chef-delivery option relates to the ability of the chef to choose to deliver a created meal to the consumer account. Accepting this responsibility may entitle the chef to a larger portion of the payment received by the consumer account. A confirmation of the chef-delivery option is relayed from the corresponding chef PC device of the desired chef account, through the remote server, and to the consumer PC device, if the chef-delivery option is confirmed by the desired chef account. Information including, but not limited to, a receipt, travel time, driver location, meal handling instructions, and more may be included in the confirmation. The confirmation of the chef-delivery option is displayed with the consumer PC device. Thus, the consumer account is made aware of the accepted responsibility of the desired chef account to deliver food. In this way, the desired chef account may accept delivery duty and proceed to deliver a cooked meal to the consumer account.

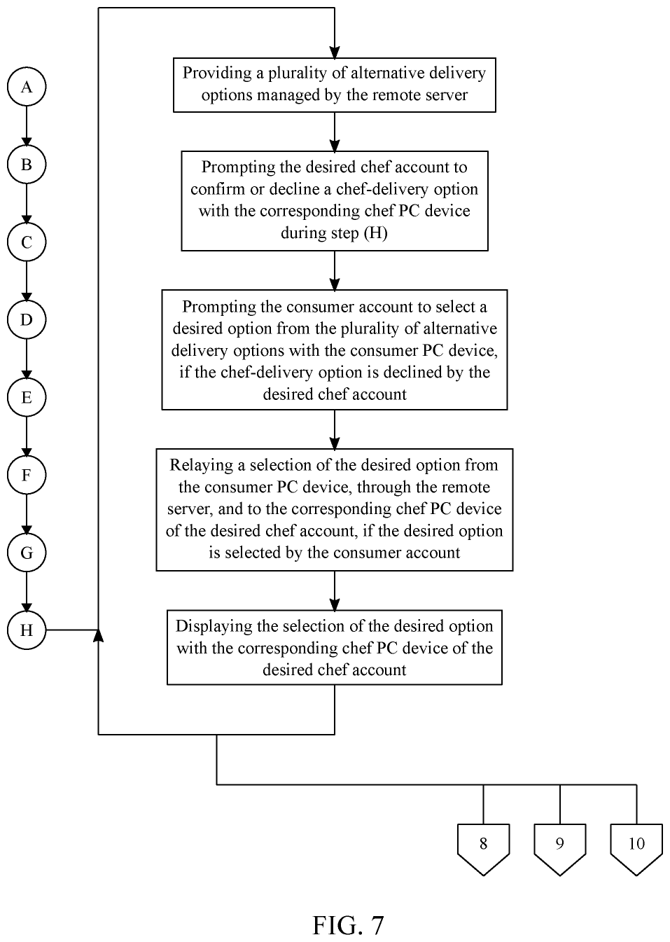

In a similar scenario, the chef may desire not to deliver the created food after cooking. To allow for such a scenario, a plurality of alternative delivery options is provided and managed by the remote server, which is shown in FIG. 7. The plurality of alternative delivery options relates to any of third-party delivery services, pick-up option, or an internal delivery option. The desired chef account is prompted to confirm or decline a chef-delivery option with the corresponding chef PC device during Step H. This arrangement allows the desired chef account to determine whether to deliver the created food or not. The consumer account is prompted to select a desired option from the plurality of alternative delivery options with the consumer PC device, if the chef-delivery option is declined by the desired chef account. In this way, the consumer account may select a most appropriate delivery method other than the desired chef account delivering the meal. A selection of the desired option is relayed from the consumer PC device, through the remote server, and to the corresponding chef PC device of the desired chef account, if the desired option is selected by the consumer account. Thus, the desired chef account is provided with the preferred delivery method of the consumer account. The selection of the desired option is displayed with the corresponding chef PC device of the desired chef account. In this way, the desired chef account may determine appropriate packaging and travel preparations necessary for efficient and safe food delivery.

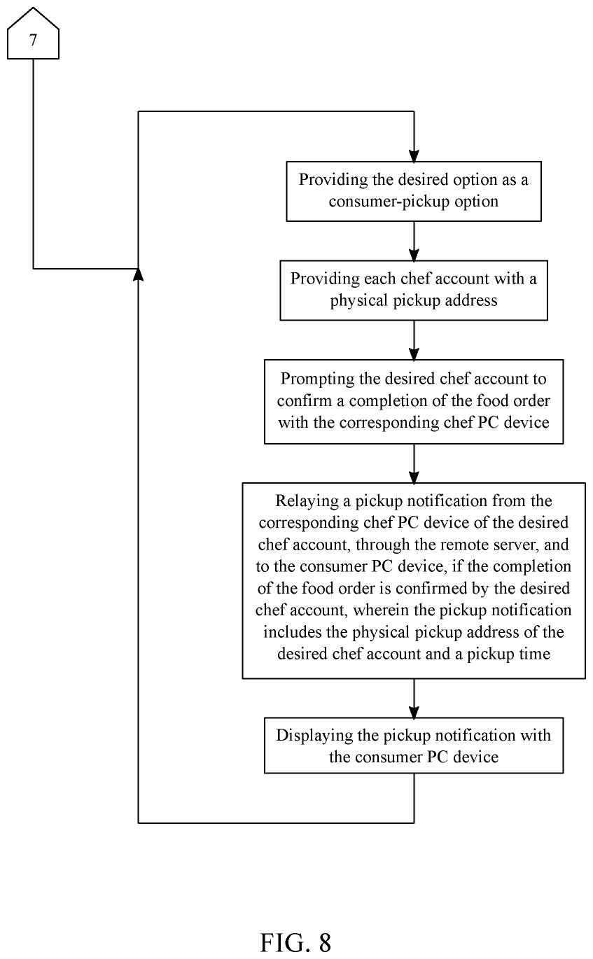

The consumer account may be within an appropriate distance of the desired chef account and may therefore desire to claim the meal in person. To accommodate for this possibility, the desired option is provided as a consumer pick-up option, which is shown in FIG. 8. The consumer pick-up option relates to a food acquisition method that avoids the extra expenses and time delay associated with food delivery. Furthermore, each chef account is provided with a physical pickup address. The physical pickup address is an area in which the chef has agreed to hand off the created food at an agreed-upon time. The desired chef account is prompted to confirm a completion of the food order with the corresponding chef PC device. This arrangement allows for the generation of a reminder to the consumer account about the approaching pickup time. A pickup notification is relayed from the corresponding chef PC device of the desired chef account, through the remote server, and to the consumer PC device, if the completion of the food order is confirmed by the desired chef account, wherein the pickup notification includes the physical pickup address of the desired chef account and a pickup time. Thus, the consumer PC device is provided with information necessary for the consumer account to receive. The pickup notification is then displayed with the consumer PC device. This arrangement ensures that both the consumer account and the desired chef account are aware of the pickup time and the pickup location, thus facilitating the exchange of the meal.

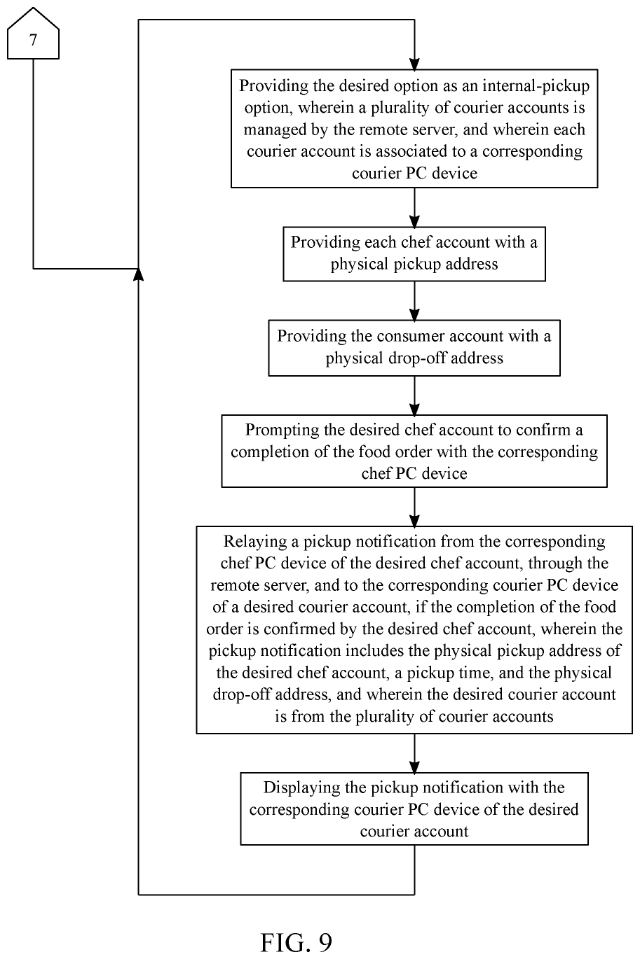

As can be seen in FIG. 9, the remote server may contain driver information for several drivers willing to deliver food to the consumer account. To this end, the desired option is provided as an internal-pickup option, wherein a plurality of courier accounts is managed by the remote server, and wherein each courier account is associated to a corresponding courier PC device. Such an option may be found to be the least expensive or most available option for the consumer account depending on the location, time of day, and other such variables. Each chef account is provided with a physical pickup address. The physical pickup address relates to an agreed-upon location for the desired chef account to leave the meal for subsequent retrieval by a courier account from the plurality of courier accounts. The consumer account is provided with a physical drop-off address. The physical pickup address relates to an agreed-upon location for the consumer account to collect the meal delivered by a courier account from the plurality of courier accounts. The desired chef account is prompted to confirm a completion of the food order with the corresponding chef PC device. This arrangement allows for the generation of a reminder to the courier account about the approaching pickup time. A pickup notification is relayed from the corresponding chef PC device of the desired chef account, through the remote server, and to the corresponding courier PC device, if the completion of the food order is confirmed by the desired chef account, wherein the pickup notification includes the physical pickup address of the desired chef account, a pickup time, and the physical drop-off address, and wherein the desired courier account is from the plurality of courier accounts. Thus, the corresponding courier PC device is provided with information necessary for the desired courier account to receive. Finally, the pickup notification is displayed with the corresponding courier PC device of the desired courier account. Thus, the corresponding courier account is prepared with information necessary to arrive at the pickup time at the physical drop-off address.

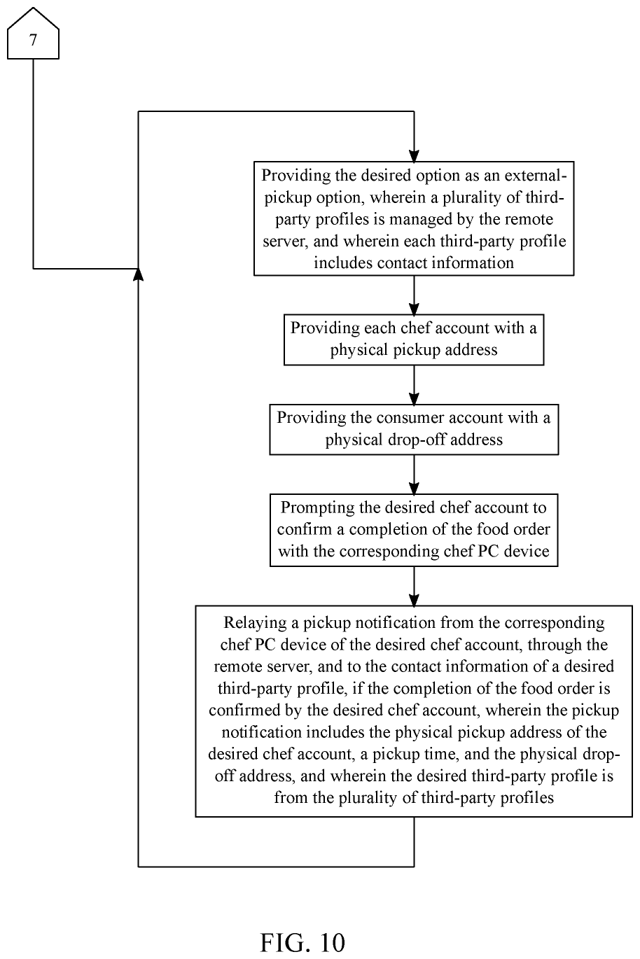

As can be seen in FIG. 10, the remote server may further contain driver information for a set of drivers who are not directly affiliated with the present system, but rather drive for third party delivery companies which may be less expensive for the consumer account to utilize. To this end, the desired option is provided as an external-pickup option, wherein a plurality of third-party profiles is managed by the remote server, and wherein each third-party profile includes contact information. Such an option may be found to be the least expensive or most available option for the consumer account depending on the location, time of day, and other such variables. Each chef account is provided with a physical pickup address. The physical pickup address relates to an agreed-upon location for the desired chef account to leave the meal for subsequent retrieval by a third-party profile from the plurality of third-party profiles. The consumer account is provided with a physical drop-off address. The physical pickup address relates to an agreed-upon location for the consumer account to collect the meal delivered by a third-party profile from the plurality of third-party profiles. The desired chef account is prompted to confirm a completion of the food order with the corresponding chef PC device. This arrangement allows for the generation of a reminder to the third-party profile about the approaching pickup time. A pickup notification is relayed from the corresponding chef PC device of the desired chef account, through the remote server, and to the contact information of a desired third-party profile, if the completion of the food order is confirmed by the desired chef account, wherein the pickup notification includes the physical pickup address of the desired chef account, a pickup time, and the physical drop-off address, and wherein the desired third-party profile is from the plurality of third-party profiles. Thus, the third-party profile contact information is provided with information necessary for the desired third-party profile to receive.

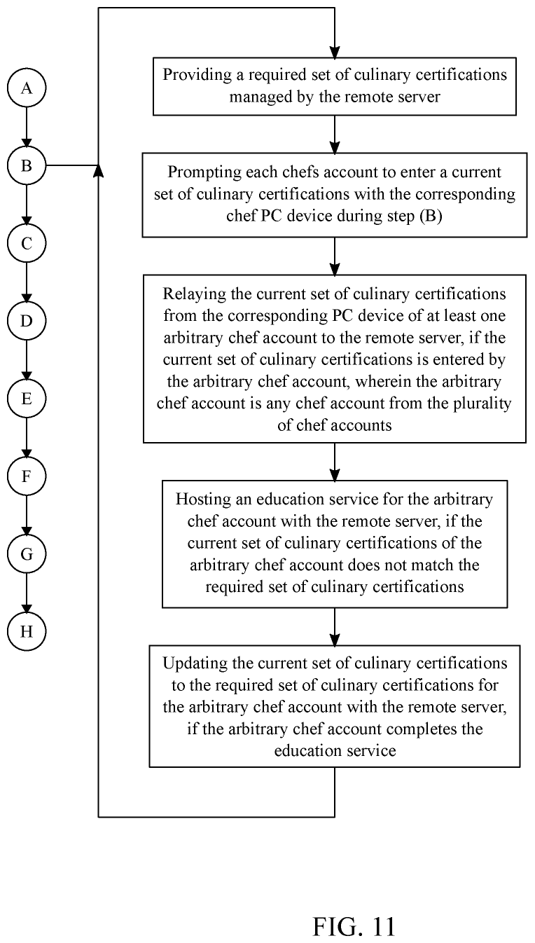

Several states and nationalities have strict guidelines, certifications, licenses, and more that must be met in order to legally sell or distribute cooked food items. To accommodate for this need, a required set of culinary certifications managed by the remote server is provided, which is shown in FIG. 11. The required set of culinary certifications may include licensure for sanitization, food storage, handling, preparations, shipping, and more as applicable to a country, state, municipality, or other geographical or legislative region. Each chef account is prompted to enter a current set of culinary certifications with the corresponding chef PC device during Step B. Thus, a user desiring to register as a chef account may provide any certifications and qualifications that the user has collected to the remote server. The current set of culinary certifications is relayed from the corresponding PC device of at least one arbitrary chef account to the remote server, if the current set of culinary certifications is entered by the arbitrary chef account, wherein the arbitrary chef account is any chef account from the plurality of chef accounts. In this way, the remote server is equipped to analyze and respond to the provided documentation as such documents correlate to the required set of culinary certifications. An education service is hosted for the arbitrary chef account with the remote server, if the current set of culinary certifications of the arbitrary chef account does not match the required set of culinary certifications. This arrangement allows a user attempting to become a chef account to obtain knowledge necessary to legally distribute food. Finally, the current set of culinary certifications is updated to the required set of culinary certifications for the arbitrary chef account with the remote server, if the arbitrary chef account completes the education service. This allows the user to qualify to become a chef account and begin interacting with potential clients.

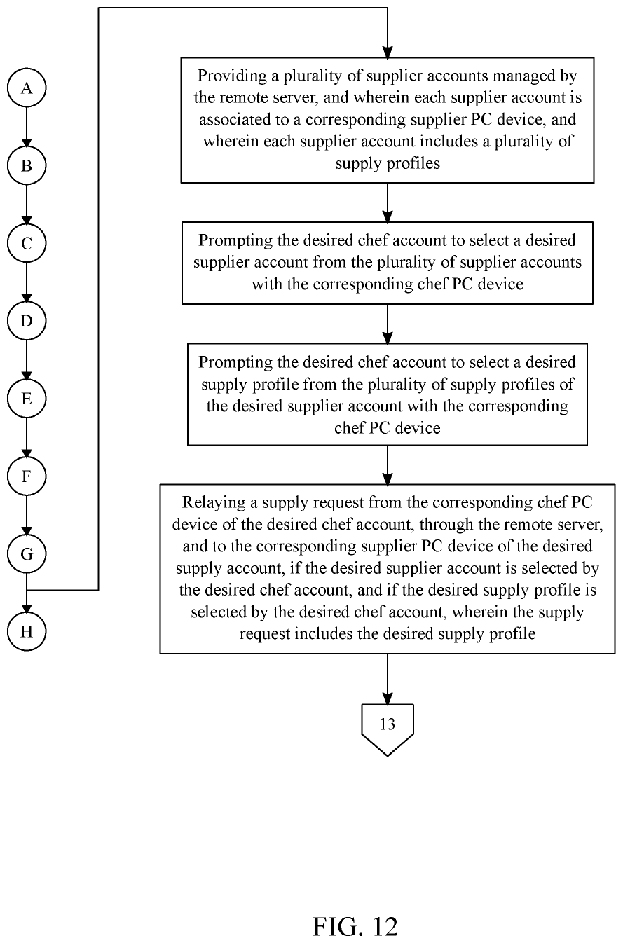

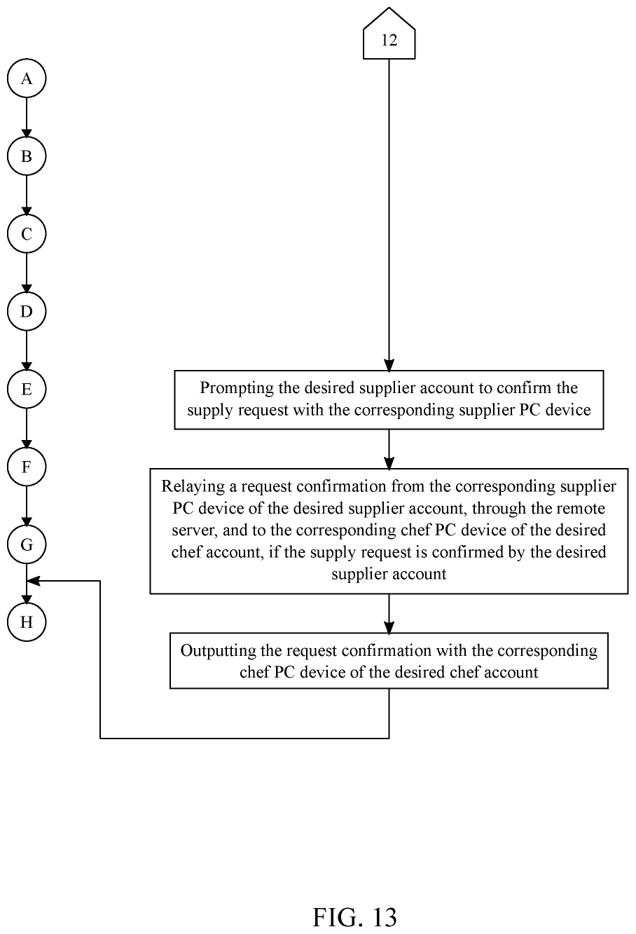

As can be seen in FIGS. 12 and 13, a chef account of the present invention would benefit from financial incentives and partnerships that enable the chef account to save or make more money. Therefore, a plurality of supplier accounts managed by the remote server is provided, wherein each supplier account is associated to a corresponding supplier PC device, and wherein each supplier account includes a plurality of supply profiles. The plurality of supplier accounts relates to a set of accounts that manage tools, items, ingredients, and other such supplies necessary to effectively run a kitchen. The desired chef account is prompted to select a desired supplier account from the plurality of supplier accounts with the corresponding chef PC device. In this way, the desired chef account may pick from a variety of available and participating supplier accounts when shopping for supplies. Next, the desired chef account is prompted to select a desired supply profile from the plurality of supply profiles of the desired supplier account with the corresponding chef PC device. Thus, the user selects desired or necessary items from the desired supplier account for purchase. A supply request is relayed from the corresponding chef PC device of the desired chef account, through the remote server, and to the corresponding supplier PC device of the desired supply account, if the desired supplier account is selected by the desired chef account, and if the desired supply profile is selected by the desired chef account, wherein the supply request includes the desired supply profile. The supply request may include information regarding any item or set of items requested by the desired chef account, including ingredients, cooking tools, utensils, containers, sanitization tools, and more. The desired supplier account is prompted to confirm the supply request with the corresponding supplier PC device. This arrangement allows the desired supplier account to check inventory and logistics before accepting the supply request. A request confirmation is relayed from the corresponding supplier PC device of the desired supplier account, through the remote server, and to the corresponding chef PC device of the desired chef account, if the supply request is confirmed by the desired supplier account. The request confirmation provides the corresponding chef PC device with the information necessary for transmission to the desired chef account. Finally, the request confirmation is outputted with the corresponding chef PC device of the desired chef account. This arrangement enables the desired chef account to receive the request confirmation from the desired supplier account. Overall, this process enables the user to save money when purchasing supplies by benefitting from exclusive discounts.

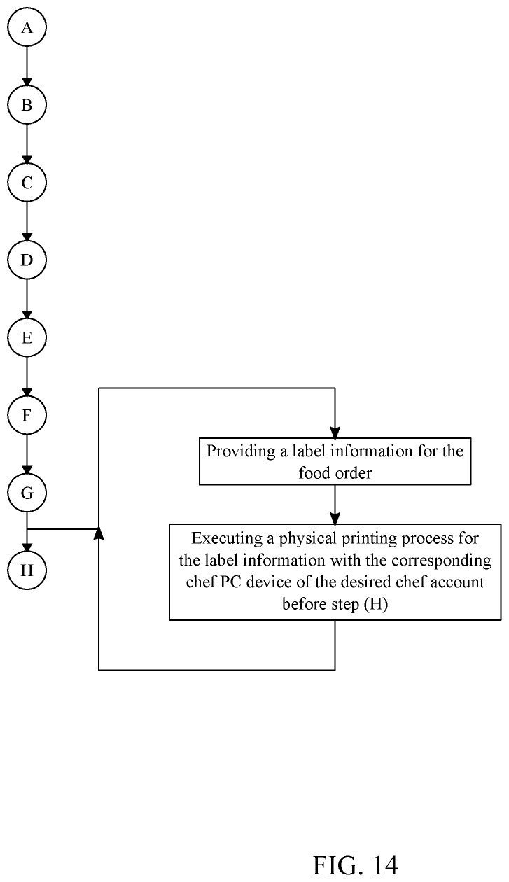

During shipping and consumption, many food items require special handling instructions and labels; for example, meal name, consumer account information, nutrition labels, high temperature warnings, low temperature warnings, vegan certifications, kosher certifications, spicy food warnings, and more. To accommodate for this need, a label information for the food order is provided, which is shown in FIG. 14. The label information may include details about the contents of a particular food container. A physical printing process is executed for the label information with the corresponding chef PC device of the desired chef account before Step H. The physical printing process provides the desired chef account with the label information in a convenient form that facilitates attachment to a meal container.

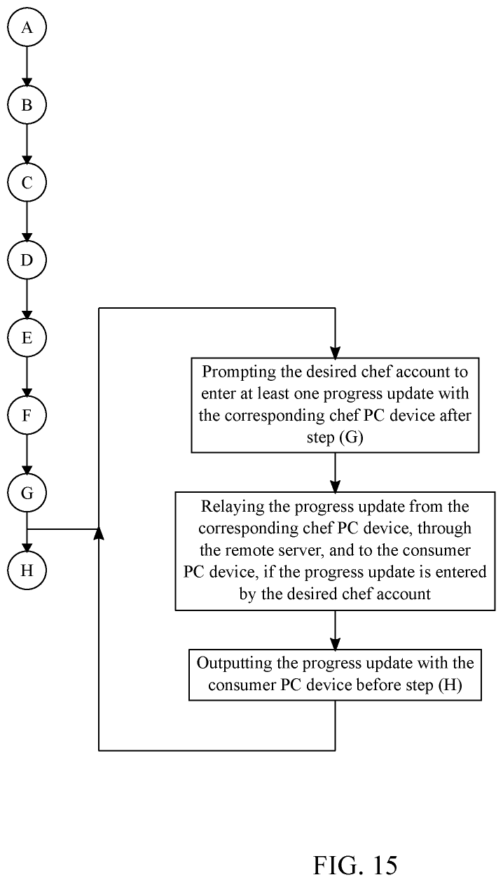

As can be seen in FIG. 15, a consumer account may become worried about the progress of food preparation and may desire warnings or notifications about the food-making process. Therefore, the desired chef account is prompted to enter at least one progress update with the corresponding chef PC device after Step G. The at least one progress update relates to a notification that may include any of text, images, video files, audio files, or other datatypes capable of providing the consumer account with necessary information. The progress update is relayed from the corresponding chef PC device, through the remote server, and to the consumer PC device, if the progress update is entered by the desired chef account. Thus, the consumer PC device is provided with the information necessary for the consumer account to receive. The progress update is outputted with the consumer PC device before Step H. Therefore, the consumer account may view the progress of the meal as cooking and preparations occur.

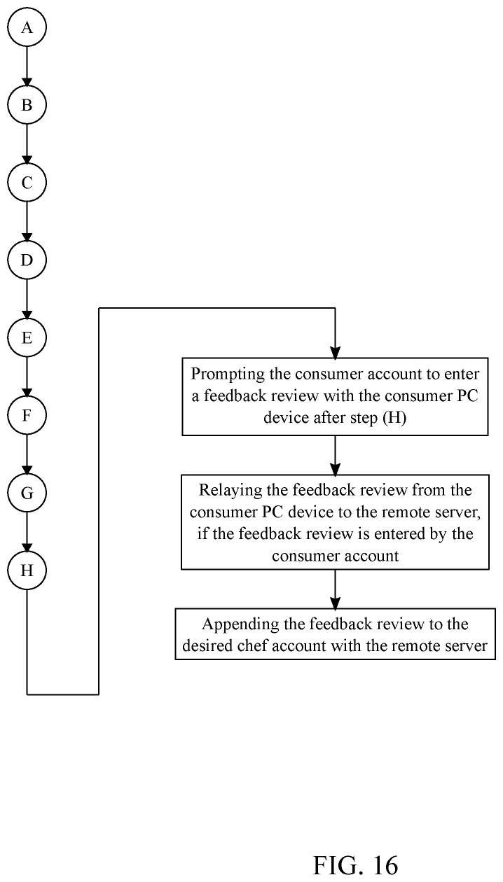

In order to distinguish between the highest quality food and service, many food services utilize ranking systems and other such tools to collect consumer feedback and thus generate valuable quantitative measurements for subsequent usage by remote servers and controllers. Such data is especially invaluable for training AI and ML algorithms to perform tasks more carefully than humans. To allow for this function, the consumer account is prompted to enter a feedback review with the consumer PC device after Step H, which is shown in FIG. 16. The feedback review may take the form of any or all of text comments, ratings, photos, and more. The feedback review is relayed from the consumer PC device to the remote server, if the feedback review is entered by the consumer account. In this way, the remote server is provided with both quantitative and qualitative information regarding the service provided to the consumer account. Next, the feedback review is appended to the desired chef account with the remote server. This arrangement allows the feedback review to appear in subsequent searches by the at least one consumer account.

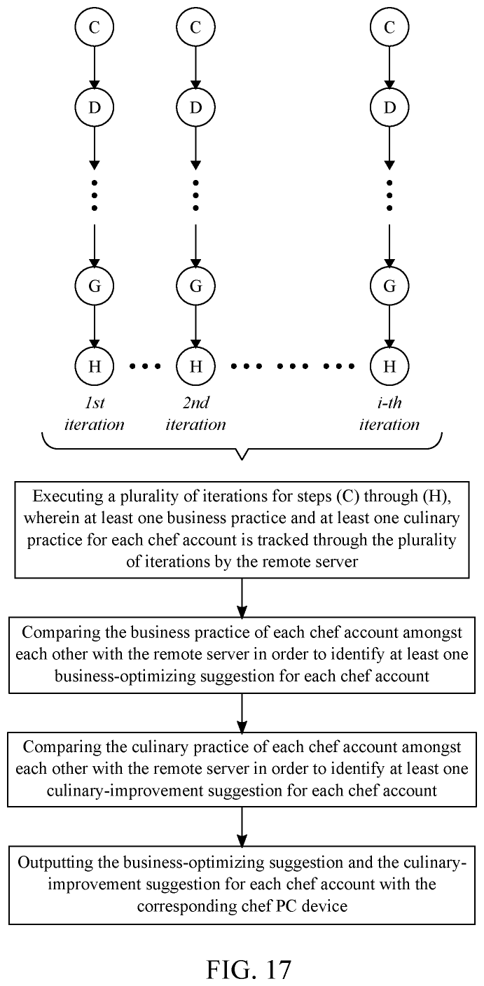

As the plurality of chef accounts are effectively starting a cooking business for themselves, each chef account may benefit from receiving advice catered to their particular service, whether that be with respect to suggested food offerings, tools, marketing methods, or more. As can be seen in FIG. 17, to enable this, a plurality of iterations for steps C through H are executed, wherein at least one business practice and at least one culinary practice for each chef account is tracked through the plurality of iterations by the remote server. This arrangement enables the remote server to collect data regarding standard practices of the chef account. The business practice of each chef account is compared amongst each other with the remote server in order to identify at least one business-optimizing suggestion for each chef account. In this way, the remote server is equipped to provide information that allows each chef account to benefit from their peers. Similarly, the culinary practice of each chef account is compared amongst each other with the remote server in order to identify at least one culinary-improvement suggestion for each chef account. In this way, the remote server identifies areas of cooking technique or practices that could use improvement. Subsequently, the business-optimizing suggestion and the culinary-improvement suggestion are outputted for each chef account with the corresponding chef PC device. Thus, the chef account receives customized information regarding potential modifications to cooking, pricing, advertising, and more practices, thus optimizing earning potential and maximizing client satisfaction.

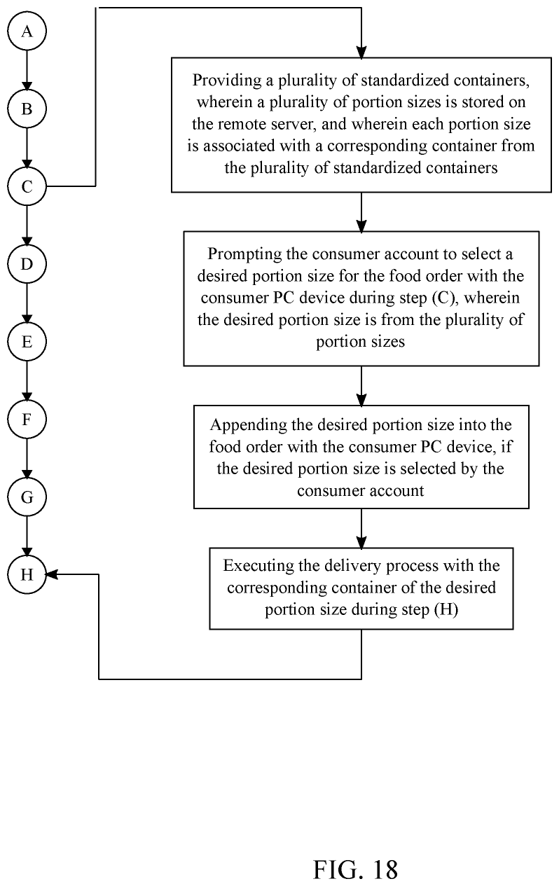

As can be seen in FIG. 18, a consumer account may be concerned about receiving an appropriate quantity of food from a desired chef account, which may negatively impact the experience of the consumer account. In order to prevent this, a plurality of standardized containers is provided, wherein a plurality of portion sizes is stored on the remote server, and wherein each portion size is associated with a corresponding container from the plurality of standardized containers. The plurality of portion sizes may be determined by the desired chef account and may be available to the consumer account for viewing before committing to purchase a given meal. The consumer account is prompted to select a desired portion size for the food order with the consumer PC device during Step C, wherein the desired portion size is from the plurality of portion sizes. The user can thus rest assured that the portion being provided is of a standardized quantity as desired. The desired portion size is appended into the food order with the consumer PC device, if the desired portion size is selected by the consumer account. This arrangement enables the desired chef account to view the desired portion size within the food order. Finally, the delivery process is executed with the corresponding container of the desired portion size during Step H. Thus, the delivery process ultimately transports a container with a standardized volume or mass of food.

### Supplemental Description

The present invention provides systems and methods for online homemade food sales powered by AI/ML, standardization, and other plurality of methodologies. The present invention preferably provides a platform comprising a software application, preferably referred to as Foodways App. In the preferred embodiment of the present invention, the platform of the present invention comprises a system architecture which facilitates the sale of homecooked food from people's own kitchens in either a private and/or public community. In the preferred embodiment of the present invention, the present invention enables users to prepare and deliver homecooked food and preferably referred to as cooks. Further, the present invention enables users to order and purchase homecooked food from the plurality of cooks and are preferably referred to as consumers. The plurality of users can register with the system of the present invention as both cooks and consumers. The system of the present invention further comprises a plurality of services which facilitate the preparation, cooking, packaging, and/or delivery of the homecooked meals by the plurality of cooks. In the preferred embodiment of the present invention, the platform of the present invention comprises at least one software application. The software application, preferably referred to as Foodways App, comprises a system which can be designed to operate in various computing devices, such as smartphones, laptops, tablets, etc. Further, the software application of the present invention can be designed to operate in conjunction with or be integrated on third-party applications, such as web browsers or search engines, in the form of extensions, add-ons, etc. In alternate embodiments of the present invention, the software application of the present invention can be designed to operate in different computing systems.

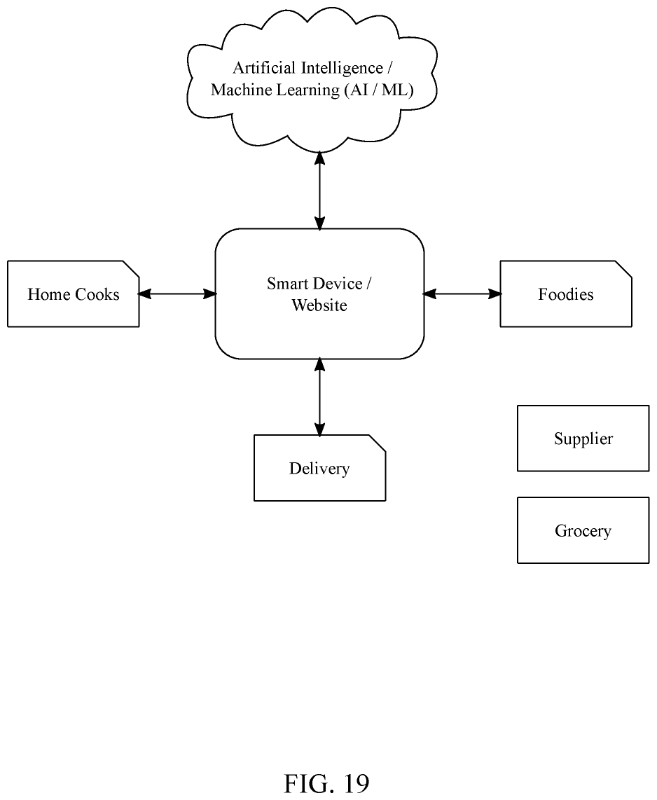

In the preferred embodiment of the present invention, the system of the present invention utilizes AI and ML systems to facilitate the operation of the present invention. As can be seen in FIG. 19, the system of the present invention utilizes AI and ML to automate and/or semi-automate a plurality of processes performed by the software application of the present invention. The AWL features of the present invention provide a plurality of automated services to consumers through the software application such as providing the best diet to users based on order history and/or ingredients, suggest cuisine options as well as cooks based on the users' tastes, etc. Further, the AWL features of the present invention provide a plurality of automated services to cooks through the software application such as automatically creating ingredients lists, suggest the addition/removal of ingredients based on dietary needs, suggest prices based on demand, create shopping lists based on ingredients, etc. In addition, the AI/ML, features of the present invention provide a plurality of automated services to users based on location, such as help users find local matches during travel. Furthermore, the AI/ML features of the present invention facilitate the creation or maintenance of user accounts/profiles by providing a plurality of automated services such as suggesting which media to utilize for marketing or helping users weed out a plurality of cooks or a plurality of consumers based on various activities or scores. In alternate embodiments of the present invention, the AI/ML, features of the present invention may provide additional features or services to further facilitate the operation of the software application of the present invention.

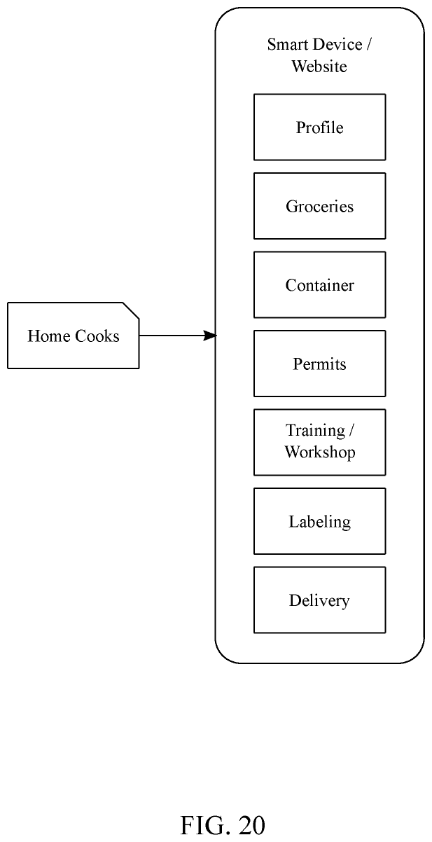

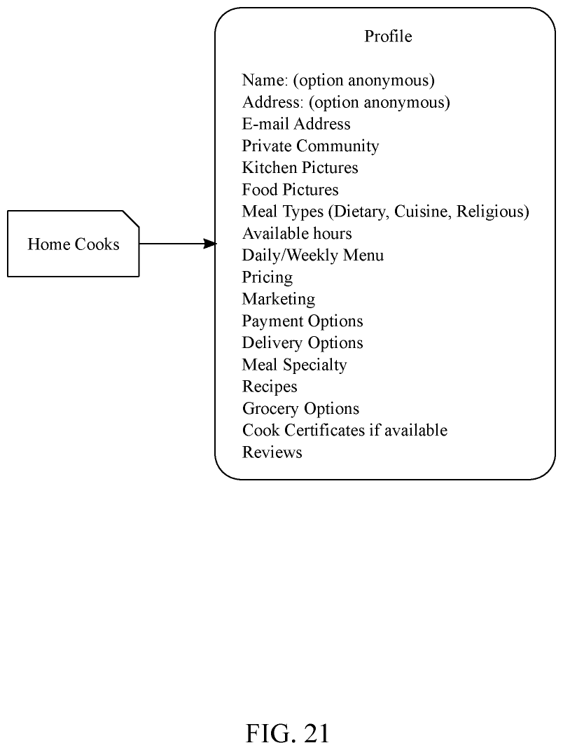

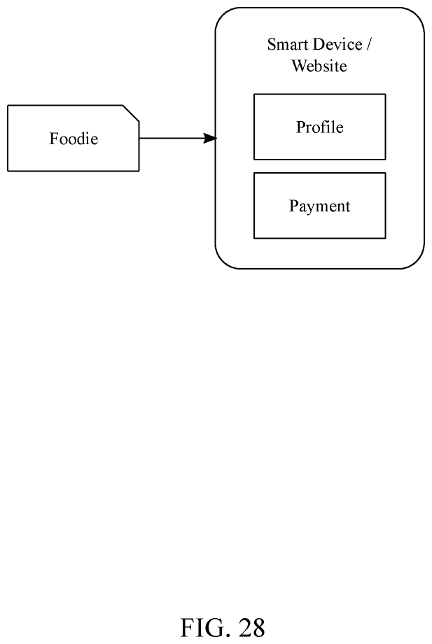

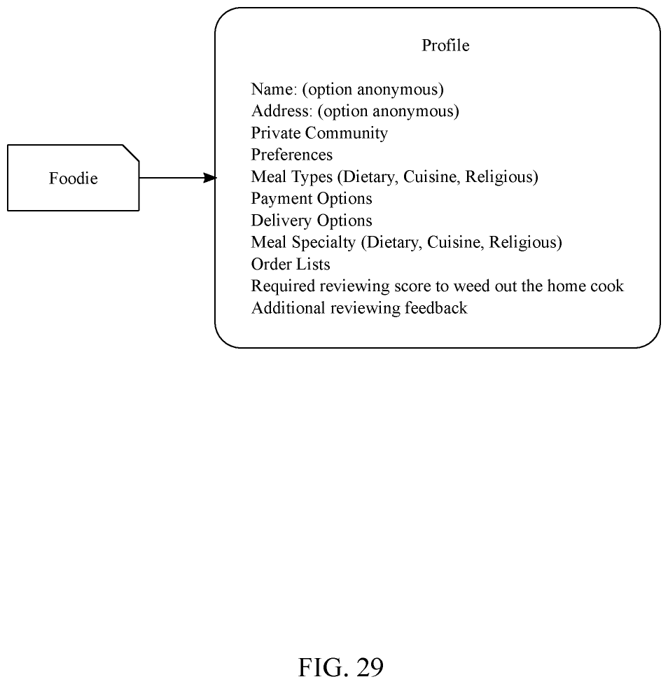

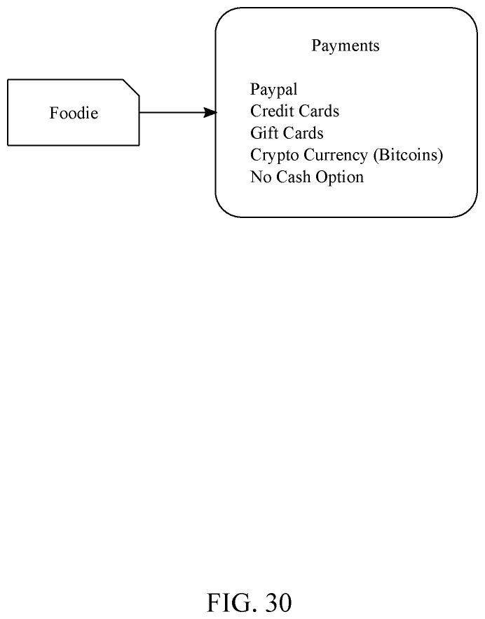

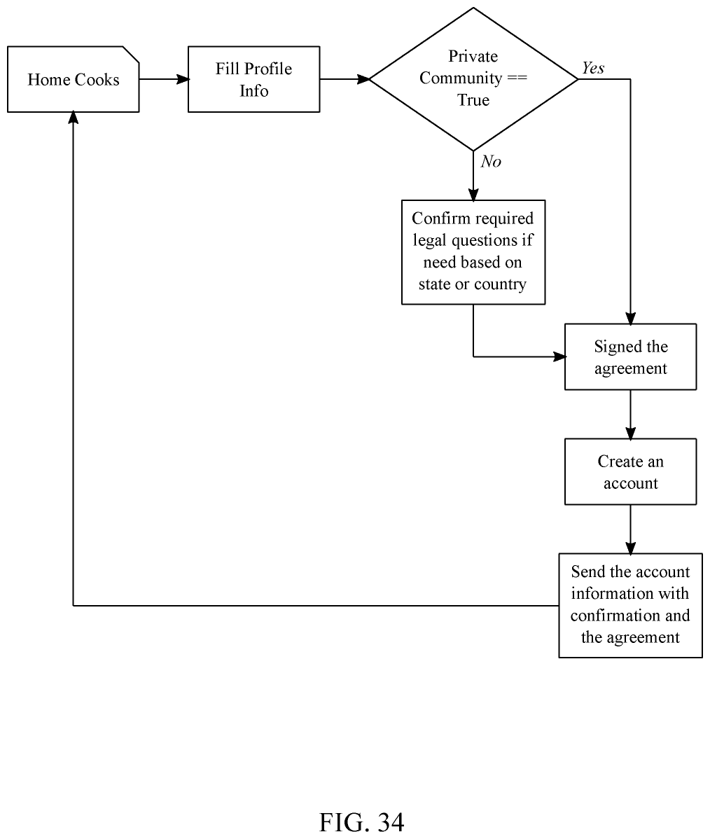

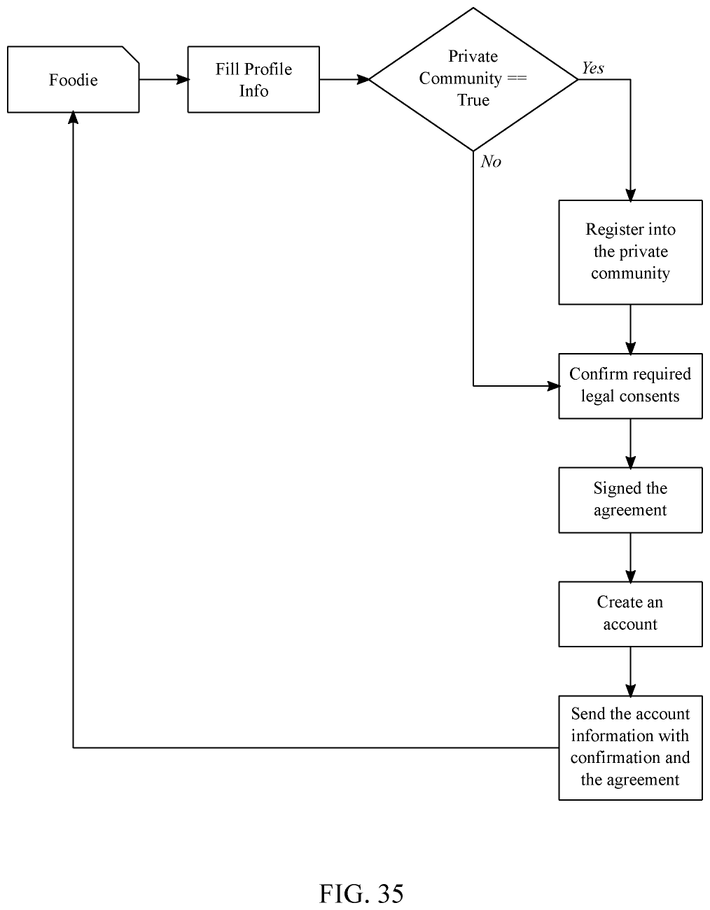

In the preferred embodiment of the present invention, the software application of the present invention enables users to create one or more user accounts. As can be seen in FIGS. 20-21 and FIG. 34, the software application enables users to create a cook account by providing user information, contact information, facility information, menu information, management information, legal information, etc. As can be seen in FIGS. 20-21 and FIG. 34, the facility information can include, but is not limited to, kitchen pictures, food pictures, etc. The menu information can include, but is not limited to, meal types, periodic menu, pricing, recipes, etc. Management information can include, but is not limited to, marketing, payment options, delivery options, grocery options, etc. Legal information can include, but is not limited to, certificates, licenses, etc. Likewise, the software application enables users to create a consumer account by providing user information, food preferences, payment options, delivery options, etc. As can be seen in FIGS. 28-30 and FIG. 35, consumers can provide food preferences such as preferred meal types, meal specialties, order lists, etc. Furthermore, the software application of the present invention enables users to provide feedback and reviews. In alternate embodiments of the present invention, the software application of the present invention can provide additional account features for cooks and consumers according to the community, location, etc.

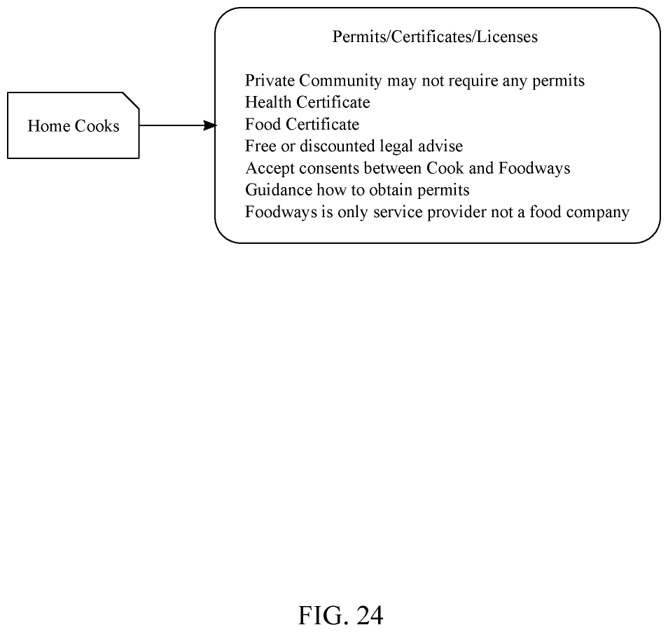

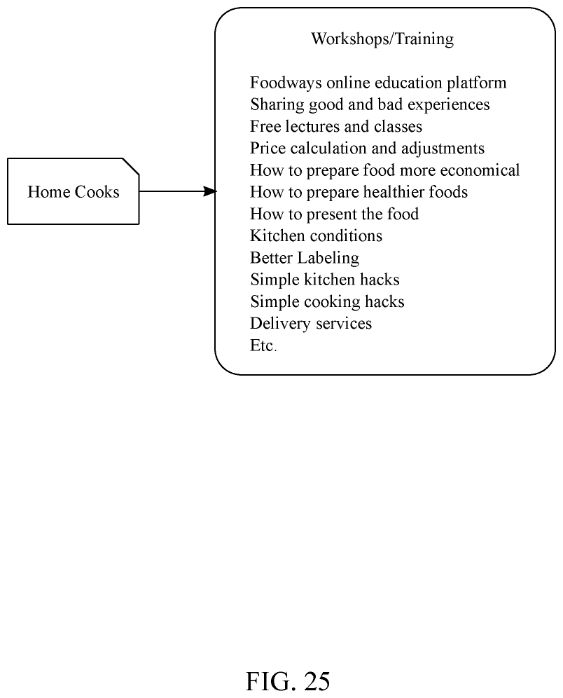

In the preferred embodiment of the present invention, the present invention provides cooks with legal and educational services. As can be seen in FIGS. 24-25, the legal services of the present invention can include, but are not limited to, operational permits, food and health certificates, consent forms, etc. In the preferred embodiment of the present invention, the legal services of the present invention may depend on the location of operation of the plurality of cooks of the present invention. In some embodiments of the present invention, the legal services of the present invention can be limited by only providing assistance/guidance on obtaining the necessary licenses, permits, etc. Likewise, the educational services of the present invention can be provided according to the cooks' needs. As can be seen in FIG. 25, the educational services can include workshops or training for cooks to learn how to more efficiently manage the business, operate more efficiently, prepare healthier food items, etc. In the preferred embodiment of the present invention, the legal and educational services of the present invention can be provided through the software application of the present invention. In alternate embodiments of the present invention, the legal and educational services can be provided through different communication methods or can be provided through third-party services.

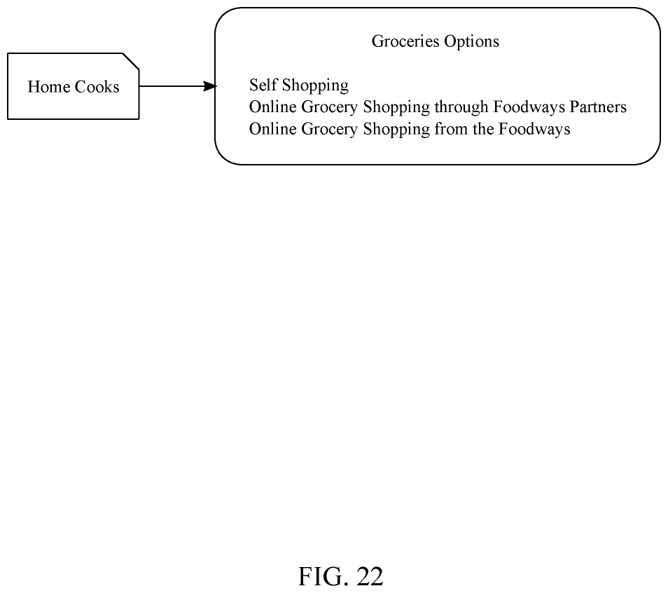

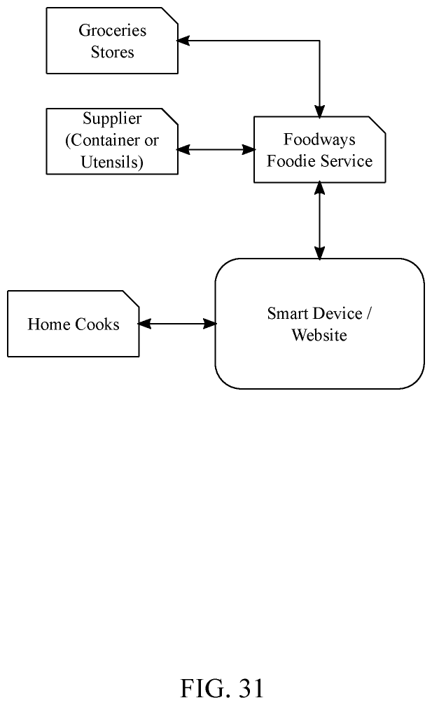

In the preferred embodiment of the present invention, the system of the present invention provides additional tools and services to cooks. As can be seen in FIG. 20, cooks of the present invention are provided with a plurality of services such as grocery services, packaging and delivery services, legal services, educational services, etc. As can be seen in FIG. 22 and FIG. 31, the system of the present invention establishes a grocery supply network with partner grocery suppliers to provide cooks with discounted grocery prices. As can be seen in FIG. 22 and FIG. 31, the system of the present invention can facilitate and/or plan the ordering of groceries prior to the preparation of meal orders. In the preferred embodiment of the present invention, the groceries services can be managed by the present invention and supplied by third-party services. However, the present invention can further establish private grocery supply services with a plurality of distribution services to further reduce the operational costs for cooks. Furthermore, the system of the present invention can establish an advertisement and marketing system from local and global markets to promote grocery services or other associated services.

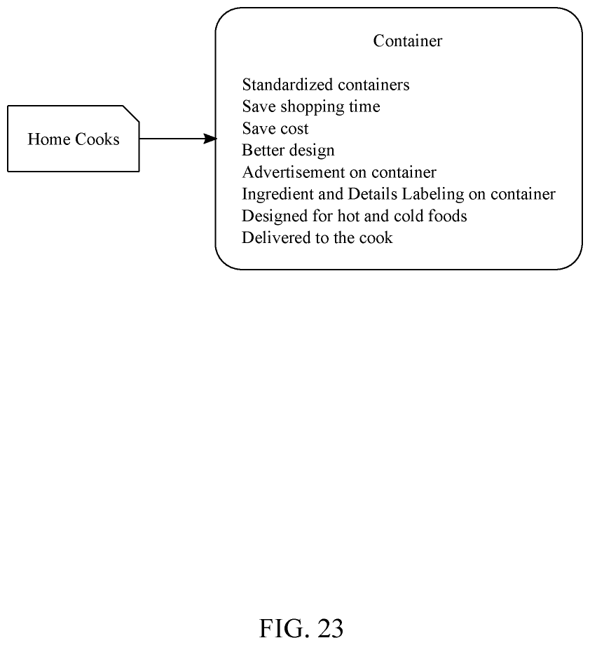

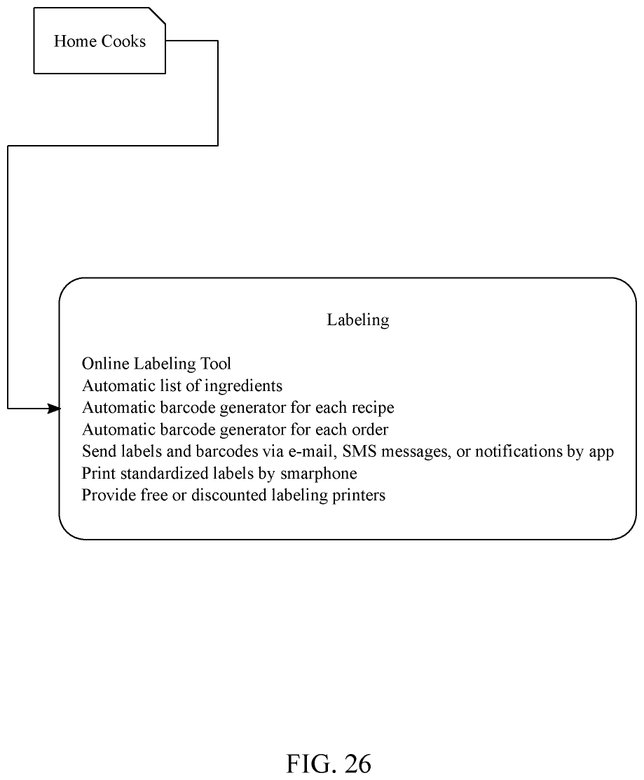

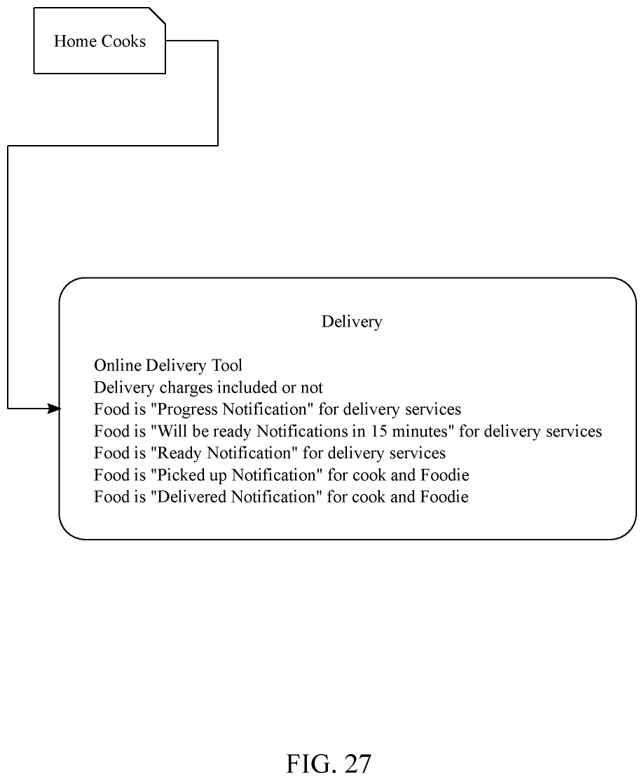

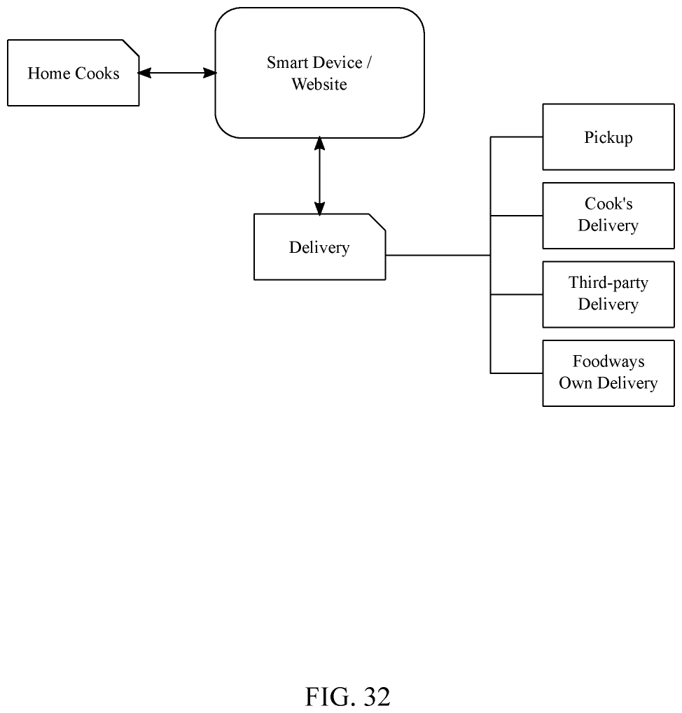

In the preferred embodiment of the present invention, the system of the present invention further provides packaging and delivery services. As can be seen in FIG. 23, the system of the present invention provides cooks with the necessary tools to package and deliver the homecooked food items. In the preferred embodiment of the present invention, the present invention provides standardized containers and utensils with a plurality of serving sizes for cooks to utilize. As can be seen in FIG. 23, the system of the present invention can provide advertisement options on the containers. Furthermore, the system of the present invention can design the containers and/or utensils for special situations depending on the food items being transported. For example, the containers provided by the present invention can be designed for transporting hot or cold foods along with the appropriate labeling and warning information according to the location's laws where the food items are being delivered. As can be seen in FIG. 26, the system of the present invention provides cooks with labeling tools to properly indicate the food items being delivered. As can be seen in FIG. 26, the system of the present invention can automatically generate list of ingredients as well as barcode labels designated for each recipe/order. In the preferred embodiment of the present invention, the system of the present invention can automatically deliver cooks the labeling materials through a plurality of methods, including, but not limited to, online methods. In alternate embodiments of the present invention, the present invention can provide cooks with discounted equipment for cooks to manually generate the necessary labeling materials. Additionally, the system of the present invention provides cooks with delivery services. As can be seen in FIG. 27 and FIG. 32, the plurality of delivery services can include, but are not limited to, scheduling delivery services, generating a plurality of notifications to parties involved, processing delivery charges etc. In the preferred embodiment of the present invention, the delivery services can be managed by the system of the present invention and provided by third-party services. In alternate embodiments of the present invention, the delivery services can be fully provided by the system of the present invention utilizing a plurality of methods, including, but not limited to, private delivery services, drone delivery services, etc.

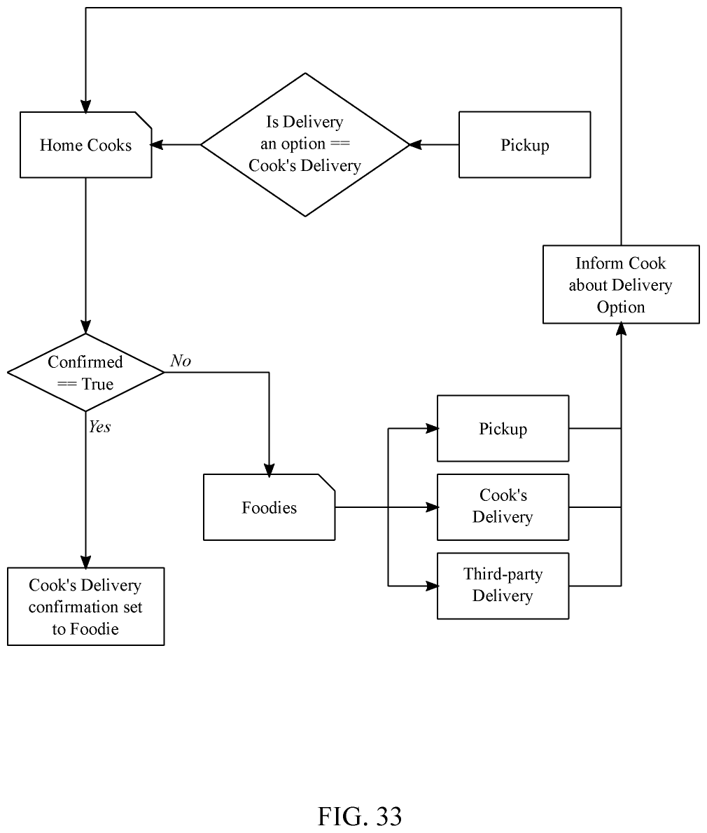

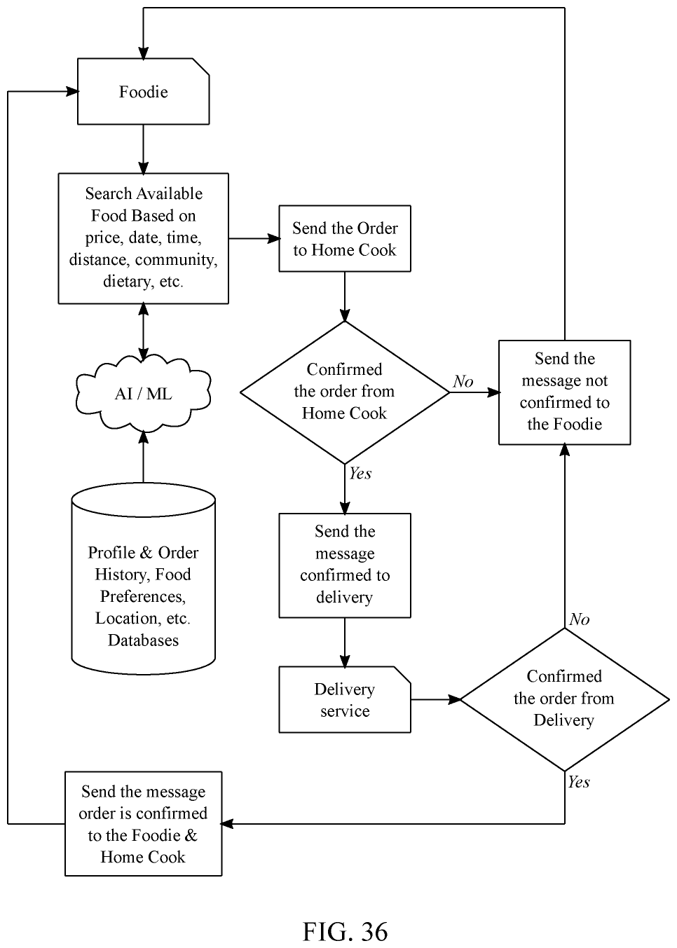

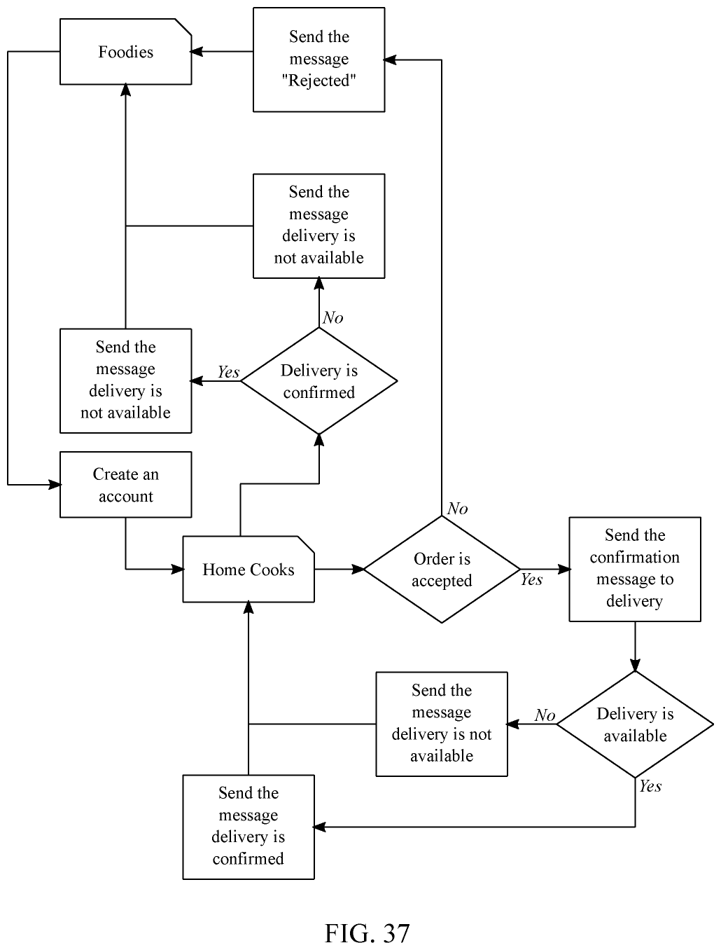

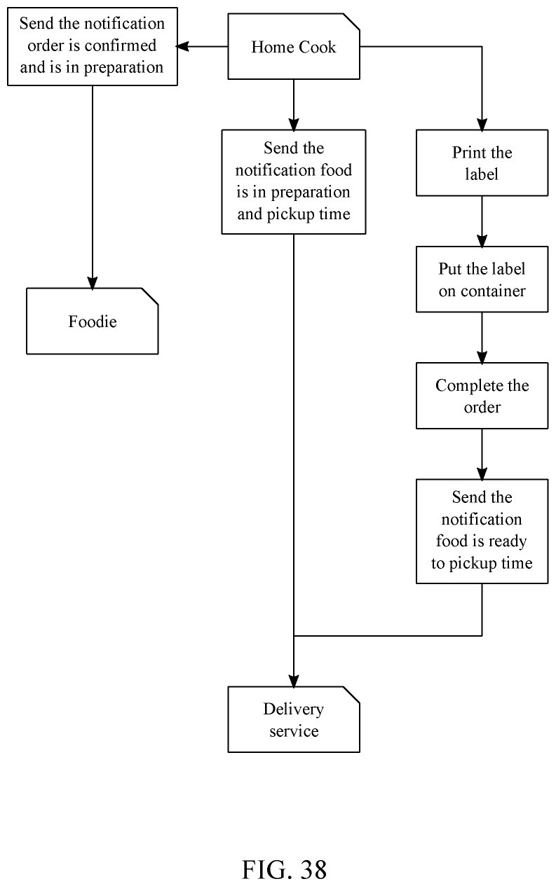

In the preferred embodiment of the present invention, the system of the present invention enables consumers to submit one or more food orders. As can be seen in FIGS. 36-37, the system of the present invention enables consumers to search a plurality of food options based on a plurality of variables, such as price, time, distance, etc. As can be seen in FIGS. 36-37, the AI/ML features of the present invention can provide consumers with a plurality of food options customized to the consumers' preferences, order history, etc. Once the one or more food options have been selected, the system of the present invention will transmit the one or more food orders to the appropriate one or more cooks. As can be seen in FIGS. 36-37 the system of the present invention enables the one or more cooks to accept/decline the one or more food orders and notifies the consumers whether the one or more food orders have been confirmed or not. Further, the system of the present invention notifies the consumers whether the delivery service for the one or more food orders have been confirmed or not. As can be seen in FIG. 33, the system of the present invention will determine and inform the one or more cooks involved in the food order regarding the consumers' delivery preference. As can be seen in FIG. 33, the system of the present invention enables the cooks' delivery confirmation to be sent to consumers once the food orders have been confirmed. Otherwise, the consumers will be notified about alternate options from which can be selected. As can be seen in FIG. 33, the system of the present invention will notify the cooks regarding the selected delivery option. Once the one or more food orders have been confirmed as well as the delivery service has been confirmed, the one or more cooks proceed to prepare the one or more orders. As can be seen in FIG. 38, the system of the present invention enables the one or more cooks to transmit a plurality of notifications to consumers regarding the status of the one or more food orders. Likewise, the system of the present invention enables the one or more cooks to transmit a plurality of notifications to the delivery services regarding the status of the one or more food orders. As can be seen in FIG. 38, once the one or more food orders have been prepared, the one or more cooks generate the necessary labels and prepare the appropriate packaging materials. As can be seen in FIG. 38, the one or more cooks package the one or more food orders and notifies the delivery services through the software application when the one or more food orders are ready to be delivered. In the preferred embodiment of the present invention, the plurality of payments involved in the one or more food orders are managed and processed through the software application of the present invention. In alternate embodiments of the present invention, the ordering, preparation, delivery, and payment processes of the present invention may be modified to meet special needs or requirements.

Although the invention has been explained in relation to its preferred embodiment, it is to be understood that many other possible modifications and variations can be made without departing from the spirit and scope of the invention as hereinafter claimed.

What is claimed is:

1. A method of managing a marketplace of homemade foods, the method comprises the steps of:
(A) providing at least one consumer account managed by at least one remote server, wherein the consumer account is associated with at least one consumer personal computing (PC) device;
(B) providing a plurality of chef accounts managed by the remote server, wherein each chef account is associated with a corresponding chef PC device;
(C) prompting the consumer account to enter a food order for a desired chef account with the consumer PC device, wherein the desired chef account is from the plurality of chef accounts;
(D) relaying the food order from the consumer PC device, through the remote server, and to the corresponding chef PC device of the desired chef account, if the food order for the desired chef account is entered by the consumer account;
(E) prompting the desired chef account to confirm the food order with the corresponding chef PC device;
(F) relaying an order confirmation from the corresponding chef PC device of the desired chef account, through the remote server, and to the consumer PC device, if the food order is confirmed by the desired chef account;
(G) outputting the order confirmation with the consumer PC device; and
(H) executing a delivery process for the food order through the remote server.

2. The method of managing a marketplace of homemade foods, the method as claimed in claim 1 comprises the steps of:
providing each chef account with a culinary profile;
prompting the consumer account to enter a chef search query with the consumer PC device before step (C);
relaying the chef search query from the consumer PC device to the remote server, if the chef search query is entered by the consumer account;
comparing the chef search query to the culinary profile of each chef account with the remote server in order to identify a plurality of preferred accounts from the plurality of chef accounts; and
prompting the consumer account to select the desired chef account from the plurality of preferred accounts with the consumer PC device.

3. The method of managing a marketplace of homemade foods, the method as claimed in claim 1 comprises the steps of:
providing each chef account with a plurality of food profiles;
prompting the consumer account to enter a food search query with the consumer PC device during step (C);
relaying the food search query from the consumer PC device to the remote server, if the food search query is entered by the consumer account;
comparing the food search query to each food profile of the desired chef account with the remote server in order to identify a plurality of preferred food profiles from the plurality of food profiles of the desired chef account;
prompting the consumer account to select a desired food profile from the plurality of preferred food profiles with the consumer PC device; and
appending the desired food profile into the food order with the consumer PC device during step (C), if the desired food profile is selected by the consumer account.

4. The method of managing a marketplace of homemade foods, the method as claimed in claim 1 comprises the steps of:
providing each chef account with a plurality of food profiles;
prompting the consumer account to view the plurality of food profiles of the desired chef account with the consumer PC device;
displaying the plurality of food profiles of the desired chef account with the consumer PC device, if the plurality of food profiles of the desired chef account is selected to be viewed by the consumer account;
prompting the consumer account to enter a new food profile for the desired chef account with the consumer PC device; and
appending the new food profile into the food order with the consumer PC device during step (C), if the new food profile is entered by the consumer account.

5. The method of managing a marketplace of homemade foods, the method as claimed in claim 1 comprises the steps of:
prompting the desired chef account to confirm or decline a chef-delivery option with the corresponding chef PC device during step (H);
relaying a confirmation of the chef-delivery option from the corresponding chef PC device of the desired chef account, through the remote server, and to the consumer PC device, if the chef-delivery option is confirmed by the desired chef account; and
displaying the confirmation of the chef-delivery option with the consumer PC device.

6. The method of managing a marketplace of homemade foods, the method as claimed in claim 1 comprises the steps of:
providing a plurality of alternative delivery options managed by the remote server;
prompting the desired chef account to confirm or decline a chef-delivery option with the corresponding chef PC device during step (H);
prompting the consumer account to select a desired option from the plurality of alternative delivery options with the consumer PC device, if the chef-delivery option is declined by the desired chef account;
relaying a selection of the desired option from the consumer PC device, through the remote server, and to the corresponding chef PC device of the desired chef account, if the desired option is selected by the consumer account; and
displaying the selection of the desired option with the corresponding chef PC device of the desired chef account.

7. The method of managing a marketplace of homemade foods, the method as claimed in claim 6 comprises the steps of:
providing the desired option as a consumer-pickup option;
providing each chef account with a physical pickup address;
prompting the desired chef account to confirm a completion of the food order with the corresponding chef PC device;
relaying a pickup notification from the corresponding chef PC device of the desired chef account, through the remote server, and to the consumer PC device, if the completion of the food order is confirmed by the desired chef account, wherein the pickup notification includes the physical pickup address of the desired chef account and a pickup time; and
displaying the pickup notification with the consumer PC device.

8. The method of managing a marketplace of homemade foods, the method as claimed in claim 6 comprises the steps of:
providing the desired option as an internal-pickup option, wherein a plurality of courier accounts is managed by the remote server, and wherein each courier account is associated to a corresponding courier PC device;
providing each chef account with a physical pickup address;
providing the consumer account with a physical drop-off address;
prompting the desired chef account to confirm a completion of the food order with the corresponding chef PC device;
relaying a pickup notification from the corresponding chef PC device of the desired chef account, through the remote server, and to the corresponding courier PC device of a desired courier account, if the completion of the food order is confirmed by the desired chef account, wherein the pickup notification includes the physical pickup address of the desired chef account, a pickup time, and the physical drop-off address, and wherein the desired courier account is from the plurality of courier accounts; and
displaying the pickup notification with the corresponding courier PC device of the desired courier account.

9. The method of managing a marketplace of homemade foods, the method as claimed in claim 6 comprises the steps of:
providing the desired option as an external-pickup option, wherein a plurality of third-party profiles is managed by the remote server, and wherein each third-party profile includes contact information;
providing each chef account with a physical pickup address;
providing the consumer account with a physical drop-off address;
prompting the desired chef account to confirm a completion of the food order with the corresponding chef PC device; and
relaying a pickup notification from the corresponding chef PC device of the desired chef account, through the remote server, and to the contact information of a desired third-party profile, if the completion of the food order is confirmed by the desired chef account, wherein the pickup notification includes the physical pickup address of the desired chef account, a pickup time, and the physical drop-off address, and wherein the desired third-party profile is from the plurality of third-party profiles.

10. The method of managing a marketplace of homemade foods, the method as claimed in claim 1 comprises the steps of:
providing a required set of culinary certifications managed by the remote server;
prompting each chef account to enter a current set of culinary certifications with the corresponding chef PC device during step (B);
relaying the current set of culinary certifications from the corresponding PC device of at least one arbitrary chef account to the remote server, if the current set of culinary certifications is entered by the arbitrary chef account, wherein the arbitrary chef account is any chef account from the plurality of chef accounts;
hosting an education service for the arbitrary chef account with the remote server, if the current set of culinary certifications of the arbitrary chef account does not match the required set of culinary certifications; and
updating the current set of culinary certifications to the required set of culinary certifications for the arbitrary chef account with the remote server, if the arbitrary chef account completes the education service.

11. The method of managing a marketplace of homemade foods, the method as claimed in claim 1 comprises the steps of:
providing a plurality of supplier accounts managed by the remote server, wherein each supplier account is associated to a corresponding supplier PC device, and wherein each supplier account includes a plurality of supply profiles;
prompting the desired chef account to select a desired supplier account from the plurality of supplier accounts with the corresponding chef PC device;
prompting the desired chef account to select a desired supply profile from the plurality of supply profiles of the desired supplier account with the corresponding chef PC device;
relaying a supply request from the corresponding chef PC device of the desired chef account, through the remote server, and to the corresponding supplier PC device of the desired supply account, if the desired supplier account is selected by the desired chef account, and if the desired supply profile is selected by the desired chef account, wherein the supply request includes the desired supply profile;
prompting the desired supplier account to confirm the supply request with the corresponding supplier PC device;
relaying a request confirmation from the corresponding supplier PC device of the desired supplier account, through the remote server, and to the corresponding chef PC device of the desired chef account, if the supply request is confirmed by the desired supplier account; and
outputting the request confirmation with the corresponding chef PC device of the desired chef account.

12. The method of managing a marketplace of homemade foods, the method as claimed in claim 1 comprises the steps of:
providing a label information for the food order; and
executing a physical printing process for the label information with the corresponding chef PC device of the desired chef account before step (H).

13. The method of managing a marketplace of homemade foods, the method as claimed in claim 1 comprises the steps of:
prompting the desired chef account to enter at least one progress update with the corresponding chef PC device after step (G);
relaying the progress update from the corresponding chef PC device, through the remote server, and to the consumer PC device, if the progress update is entered by the desired chef account; and
outputting the progress update with the consumer PC device before step (H).

14. The method of managing a marketplace of homemade foods, the method as claimed in claim 1 comprises the steps of:
prompting the consumer account to enter a feedback review with the consumer PC device after step (H);
relaying the feedback review from the consumer PC device to the remote server, if the feedback review is entered by the consumer account; and
appending the feedback review to the desired chef account with the remote server.

15. The method of managing a marketplace of homemade foods, the method as claimed in claim 1 comprises the steps of:
executing a plurality of iterations for steps (C) through (H), wherein at least one business practice and at least one culinary practice for each chef account is tracked through the plurality of iterations by the remote server;
comparing the business practice of each chef account amongst each other with the remote server in order to identify at least one business-optimizing suggestion for each chef account;
comparing the culinary practice of each chef account amongst each other with the remote server in order to identify at least one culinary-improvement suggestion for each chef account; and
outputting the business-optimizing suggestion and the culinary-improvement suggestion for each chef account with the corresponding chef PC device.

16. The method of managing a marketplace of homemade foods, the method as claimed in claim 1 comprises the steps of:
providing a plurality of standardized containers, wherein a plurality of portion sizes is stored on the remote server, and wherein each portion size is associated with a corresponding container from the plurality of standardized containers;
prompting the consumer account to select a desired portion size for the food order with the consumer PC device during step (C), wherein the desired portion size is from the plurality of portion sizes;
appending the desired portion size into the food order with the consumer PC device, if the desired portion size is selected by the consumer account; and
executing the delivery process with the corresponding container of the desired portion size during step (H).
